(19) United States
(12) Patent Application Publication
(10) Pub. No.: US 2018/0324004 A1
(43) Pub. Date: Nov. 8, 2018

(54) RADIO APPARATUS, CONTROL APPARATUS AND RADIO COMMUNICATION SYSTEM

(71) Applicant: NEC Corporation, Minato-ku, Tokyo (JP)

(72) Inventors: Jun SHIKIDA, Tokyo (JP); Naoto ISHII, Tokyo (JP)

(73) Assignee: NEC Corporation, Minato-ku, Tokyo (JP)

(21) Appl. No.: 15/771,544

(22) PCT Filed: Oct. 28, 2016
(86) PCT No.: PCT/JP2016/081996

§ 371 Date: Apr. 27, 2018

(30) Foreign Application Priority Data
Oct. 29, 2015 (JP) 2015-212520

(51) Int. Cl. H04L 25/02; H04W 72/12; H04W 72/10; H04L 1/00; H04J 11/00

(52) U.S. Cl. CPC H04L 25/0224; H04W 72/12; H04B 7/0452; H04L 1/0003; H04J 11/0023; H04W 72/10

(57) ABSTRACT

A radio apparatus is provided with: a channel estimation part that estimates a channel response between a radio terminal and the radio apparatus; a channel information generation part that generates channel information from the estimated channel response; and a transmission part that transmits the generated channel information to a control apparatus.

### REFERENCE TO RELATED APPLICATION

The present application is a National Stage Entry of PCT/JP2016/081996 filed on Oct. 28, 2016, which is based on and claims the benefit of the priority of Japanese Patent Application No. 2015-212520, filed on Oct. 29, 2015, the disclosures of all of which are incorporated herein in their entirety by reference.

### CROSS-REFERENCE TO RELATED APPLICATIONS

The present application claims priority from Japanese Patent Application No. 2015-212520 (filed on Oct. 29, 2015) the content of which is hereby incorporated in its entirety by reference into this specification.

### TECHNICAL FIELD

The present invention relates to a radio apparatus, a control apparatus and a radio communication system, in a radio communication system configuration in which functions of a wireless base station are separated into a radio apparatus and a control apparatus.

### BACKGROUND

Multi user MIMO (MU-MIMO: Multi User Multiple Input Multiple Output) transmission where signals of multiple terminals are spatially multiplexed is studied, as technology for improving spectral efficiency in a radio communication system. Non Patent Literature (NPL) 1 discloses a method which estimates channel capacity for each terminal combination using channel responses of respective terminals and selects terminals included in the terminal combination with the highest channel capacity as spatially multiplexed terminals.

Patent Literature (PTL) 1 discloses that MU-MIMO scheduling is performed only in the space axis (MIMO multiplexing layer) because one carrier is assumed in the frequency axis and has a problem that interference power is ignored because of using a signal power criterion based on the projection channel power of respective users. Therefore, as a MU-MIMO scheduling method which is matched with a frequency scheduling method using received SINR (Signal to Interference plus Noise power Ratio), Patent Literature 1 provides a scheduling method allocating RBs (Resource Blocks), which are frequency-divided blocks of the system band, to optimal users in consideration of reception quality (SINR) represented in the two dimensions of the frequency and space axes.

Meanwhile, in order to expand the network capacity in radio communication systems, small cells with low transmission power and small cell coverage have been introduced. Non-Patent Literature 2 discusses C-RAN (Cloud/Centralized Radio Access Network) that efficiently operates small cells. In C-RAN, baseband processing functions of small cells are divided into radio apparatuses on an antenna side and control apparatus on a core network side, and the control apparatus integrates a portion of baseband processing functions of multiple small cells. Non-Patent Literature 2 describes plural types of C-RAN on the basis of the functional split of baseband processing functions. In addition, Non-Patent Literature 2 describes transmission capacity required for fronthaul, which is a transmission channel between the radio apparatus and the control apparatus, and the ease of inter-cell coordination for each C-RAN type.
[PTL 1]
Japanese Patent No. 5206945B
[NPL 1]
J. Liu, X. She, L. Chen, “A low complexity capacity-greedy user selection scheme for zero-forcing beamforming,” VTC Spring 2009, April 2009.
[NPL 2]
Small Cell Forum, “Small cell virtualization functional splits and use cases” ver. 159.05.1.01, June 2015.

### SUMMARY

However, as described above, the cited documents do not give consideration to using MU-MIMO transmission in C-RAN. Therefore, in C-RAN, spatially multiplexed terminals cannot be appropriately selected, and the effect of MU-MIMO transmission cannot be obtained sufficiently. It is an object of the present invention to provide a radio apparatus, a control apparatus and a radio communication system that solve the problem that the effect of MU-MIMO transmission can be obtained sufficiently in C-RAN.

In a first aspect of the present invention a radio apparatus is provided with a channel estimation part that estimates a channel response between a radio terminal and the radio apparatus itself. The radio apparatus is provided with a channel information generation part that generates channel information from the estimated channel response. The radio apparatus is further provided with a transmission part that transmits the generated channel information to a control apparatus.

In a second aspect of the present invention a control apparatus is provided with a receiving part that receives channel information that a radio apparatus generates using an estimated channel response between a radio terminal and the radio apparatus. The control apparatus is provided with a scheduling part that generates scheduling information from the channel information. The control apparatus is further provided with a transmission part that transmits the scheduling information to the radio apparatus.

In a third aspect of the present invention a radio communication system is provided with a radio apparatus and a control apparatus. The radio apparatus is provided with a channel estimation part that estimates a channel response between a radio terminal and the radio apparatus. The radio apparatus is provided with a channel information generation part that generates channel information from the estimated channel response. The radio apparatus is further provided with a transmission part that transmits the channel information to the control apparatus. The control apparatus is provided with a scheduling part that generates scheduling information from the channel information. The control apparatus is provided with a transmission part that transmits the scheduling information to the radio apparatus.

According to the present invention, since MU-MIMO transmission can be used in C-RAN, system capacity can be improved.

### BRIEF DESCRIPTION OF DRAWINGS

FIG. 1 is a block diagram showing a configuration of a radio communication system in the present invention.

FIG. 2 is a block diagram showing a configuration example of a central baseband processing part and a remote baseband processing part in a first exemplary embodiment.

FIG. 3 is a sequence diagram showing an operation example of a control apparatus and a radio apparatus in the first exemplary embodiment.

FIG. 4 is a flowchart showing an operation example of a scheduling part in the first exemplary embodiment.

FIG. 5 is a flowchart showing an operation example for terminal selection in a scheduling part in the first exemplary embodiment.

FIG. 6 is a flowchart showing an operation example for layer number selection in a scheduling part in the first exemplary embodiment.

FIG. 7 is a flowchart showing an operation example for MCS selection in a scheduling part in the first exemplary embodiment.

FIG. 8 is a block diagram showing a configuration example of a central baseband processing part and a remote baseband processing part in a second exemplary embodiment.

FIG. 9 is a sequence diagram showing an operation example of a control apparatus and a radio apparatus in the second exemplary embodiment.

FIG. 10 is a block diagram showing a configuration example of a central baseband processing part and a remote baseband processing part in a third exemplary embodiment.

FIG. 11 is a sequence diagram showing an operation example embodiment of a control apparatus and a radio apparatus in the third exemplary embodiment.

FIG. 12 is a block diagram showing a configuration example of a central baseband processing part and a remote baseband processing part in a fourth exemplary embodiment.

FIG. 13 is a sequence diagram showing an operation example of a control apparatus and a radio apparatus in the fourth exemplary embodiment.

FIG. 14 is a block diagram showing an operation example of a control apparatus and a radio apparatus in another exemplary embodiment.

FIG. 15 is a block diagram showing a configuration example of a radio communication system according to an exemplary embodiment.

### PREFERRED MODES

When C-RAN, in which a radio apparatus and a control apparatus are physically separated, is used for operating small cells with small cell coverage, there is no means for the radio apparatus to send an estimated channel state used for MU-MIMO transmission to the control apparatus. Therefore, scheduling by the control apparatus has not been suitable for obtaining an application effect with MU-MIMO transmission.

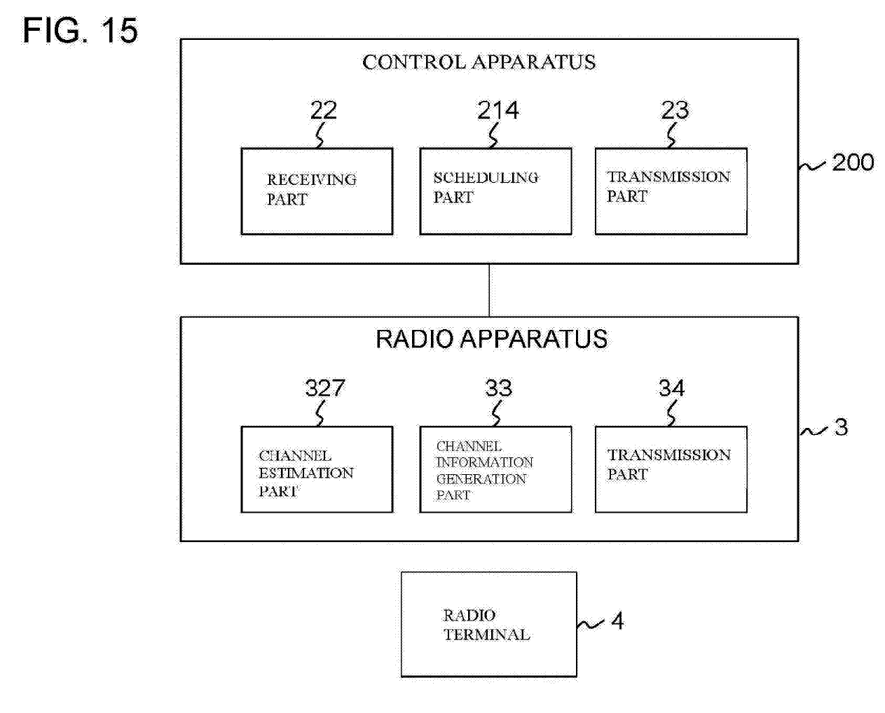

First, a description is given concerning an outline of an exemplary embodiment. It is to be noted that reference symbols in the drawings attached to this outline are examples solely for the purpose of aiding understanding and are not intended to limit the present invention to modes illustrated in the drawings. FIG. 15 is a block diagram showing an example of a configuration of a radio communication system according to the exemplary embodiment. Referring to FIG. 15, the radio communication system is provided with a radio apparatus 3 and a control apparatus 200. The radio apparatus 3 is provided with: a channel estimation part 327 that estimates a channel response between a radio terminal 4 and the radio apparatus itself 3; a channel information generation part 33 that generates channel information from the estimated channel response; and a transmission part 34 that transmits the generated channel information to the control apparatus 200. Meanwhile, the control apparatus 200 is provided with a receiving part 22 by which the radio apparatus 3 receives the generated channel information based on the estimated channel response between the radio terminal 4 and the radio apparatus 3, a scheduling part 214 that generates scheduling information from the channel information, and a transmission part 23 that transmits the scheduling information to the radio apparatus 3.

In a configuration of the exemplary embodiment of the present invention, the radio apparatus 3 is provided with the channel estimation part 327 that estimates a channel response between the radio apparatus 3 and the radio terminal 4 using a reference signal (SRS: Sounding Reference Signal) transmitted by the radio terminal 4 and the transmission part 34 that transmits the estimated channel information to the control apparatus 200; and the control apparatus 200 is provided with the scheduling part 214 that preforms scheduling using the channel information received from the radio apparatus 3.

As described above, when MU-MIMO transmission is used in C-RAN, the radio apparatus 3 is provided with the channel estimation part 327, and the control apparatus 200 performs scheduling using a channel estimation results received from the radio apparatus 3. As a result, it is possible to solve the problem that when MU-MIMO transmission is used in C-RAN resources cannot be allocated on the basis of channel state. Therefore, it is possible to expand the network capacity of a radio communication system. It is to be noted that the present invention is not limited to MU-MIMO transmission, and may be applied also to other transmission methods. A detailed description is given below concerning specific exemplary embodiments applying the present invention, making reference to the drawings. In the respective drawings, similar or corresponding elements are given the same reference symbols, and in order to clarify the description, duplicate descriptions are omitted as necessary. Those skilled in the art may apply the principles and ideas understood from the exemplary embodiments specifically described below, to various forms of wireless system.

### First Exemplary Embodiment

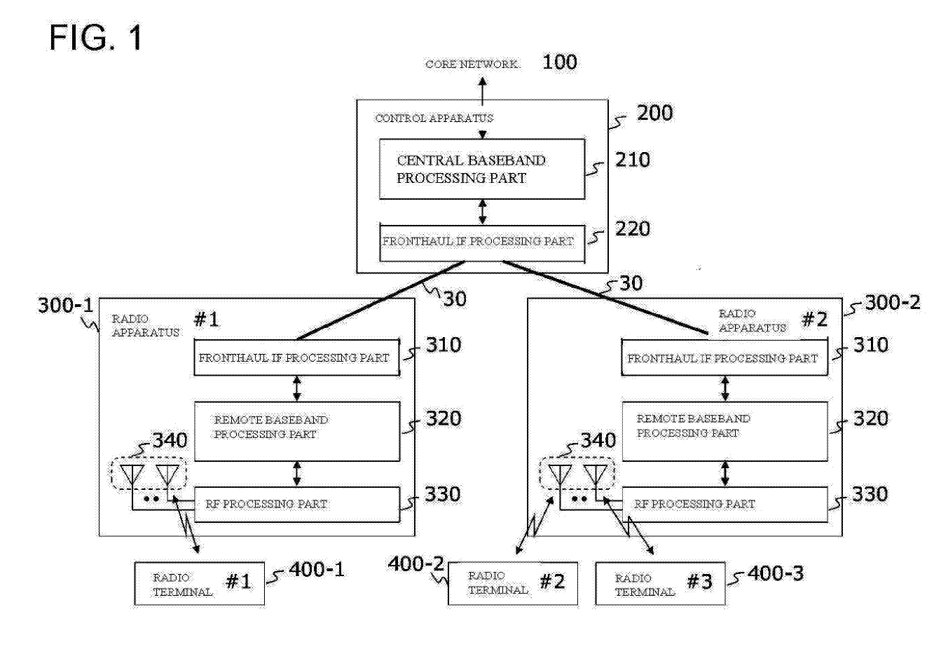

FIG. 1 is a block diagram showing a configuration of a radio communication system according to the present exemplary embodiment. The radio communication system is provided with a core network 100, a control apparatus 200, a radio apparatus 300-1 (radio apparatus #1), a radio apparatus 300-2 (radio apparatus #2), a radio terminal 400-1 (radio terminal #1), a radio terminal 400-2 (radio terminal #2), and a radio terminal 400-3 (radio terminal #3). It is to be noted that when it is unnecessary to distinguish between the radio apparatuses 300-1 and 300-2, they are simply expressed as the radio apparatus 3. Similarly when it is unnecessary to distinguish between the radio terminals 400-1, 400-2 and 400-3, they are expressed as radio terminal 4. In the radio communication system shown in FIG. 1, two radio apparatuses 3 are provided, but the number of radio apparatuses 3 is not limited to this. The same applies also for the radio terminals 4 and the number thereof is not limited. The radio terminals here are one example, and radio apparatuses having relay capability are also possible instead of the radio terminals.

The control apparatus 200 and the radio apparatus 3 are arranged at physically separated locations and are connected via a fronthaul 30. The fronthaul 30 is constructed using a medium such as optic fiber, metal cable, or radio propagation channel. The radio apparatus 3 and the radio terminal 4 are connected via radio propagation channel.

The control apparatus 200 is provided with a central baseband processing part 210 and a fronthaul interface processing part 220 (fronthaul IF processing part). The fronthaul interface processing part 220 performs processing according to the standards of the fronthaul 30 to communicate with the radio apparatus 3 via the fronthaul 30.

The radio apparatus 3 is provided with a fronthaul interface processing part 310 (fronthaul IF processing part), a remote baseband processing part 320, a RF processing part 330, and antennas 340.

The radio terminal 4 is provided with an antenna and a RF processing part.

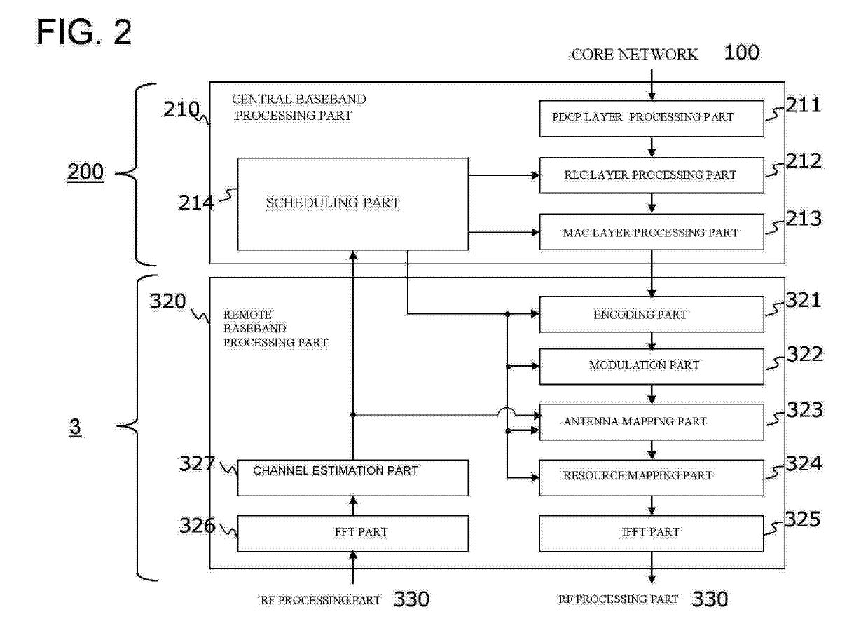

As shown in FIG. 2, the remote baseband processing part 320 in the present exemplary embodiment is provided with an FFT (Fast Fourier Transform) part 326, a channel estimation part 327, an encoding part 321, a modulator 322, an antenna mapping part 323, a resource mapping part 324, and an IFFT (Inverse Fast Fourier Transform) part 325.

The central baseband processing part 210 is provided with a scheduling part 214, a PDCP (Packet Data Convergence Protocol) layer processing part 211, an RLC (Radio Link Control) layer processing part 212, and a MAC (Media Access Control) layer processing part 213. It is to be noted that the processing parts of respective layers are described here inside the central baseband processing part 210 as an example, but they may also be inside the remote baseband processing part 320.

The RF processing part 330 of the radio apparatus 3 converts a radio frequency signal which is received from a radio terminal via the antenna 340 and includes a reference signal into a baseband signal. Then, the RF processing part 330 outputs the converted baseband signal to the FFT part 326.

The FFT part 326 performs a Fast Fourier Transform (FFT) on the baseband signal received from the RF processing part 330 and outputs the baseband signal after the FFT to the channel estimation part 327. It is to be noted that a cyclic prefix (CP) is removed between the FFT part 326 and the RF processing part 330 (not shown in the drawings).

The channel estimation part 327 estimates channel response between the radio terminal 4 and the radio apparatus 3 by using a signal received from the FFT part 326 and a reference signal which is transmitted by the radio terminal 4 and is known on the radio apparatus 3 side, and outputs the estimated value to the antenna mapping part 323 and the scheduling part 214 of the central baseband processing part 210 via the fronthaul interface processing part 310, the fronthaul 30 and the fronthaul interface processing part 220. In this regard, the radio terminal 4 that is a target for the estimation of the channel response is not limited to a radio terminal communicating with the radio apparatus 3, and estimation may also be made of a channel response with respect to a radio terminal communicating with another radio apparatus. The outputted estimated value may be averaged in a time-wise or frequency-wise manner. It is to be noted that the terminal may estimate the channel response using a reference signal and transmit the estimated channel response to the radio apparatus.

The fronthaul interface processing part 310 performs processing in conformity with standards of the fronthaul 30, in order to communicate with the control apparatus 200 via the fronthaul 30.

The scheduling part 214 allocates radio resources and Modulation Coding Scheme (MCS) to the radio terminal 4, using the estimated channel response received from the channel estimation part 327 of the remote baseband processing part 320, and outputs the allocation information to the RLC layer processing part 212, the MAC layer processing part 213, the encoding part 321, the modulation part 322, the antenna mapping part 323, and the resource mapping part 324.

The PDCP layer processing part 211 performs processing such as compression and encryption for user data sent from the core network 100 and outputs the user data after the processing to the RLC layer processing part 212.

The RLC layer processing part 212 performs buffering of data received from the PDCP layer processing part 211, and performs dividing/combining of the buffered data in conformity with a request from the scheduling part 214, and outputs to the MAC layer processing part 213.

The MAC layer processing part 213 performs multiplexing of control information and data sent from the RLC layer processing part 212 in conformity with a request from the scheduling part 214, and outputs to the encoding part 321 of the remote baseband processing part 320 via the fronthaul interface processing part 220, the fronthaul 30 and the fronthaul interface processing part 310.

The encoding part 321 encodes data received from the MAC layer processing part 213 via the fronthaul interface processing part 220, the fronthaul 30 and the fronthaul interface processing part 310, based on information sent from the scheduling part 214, and outputs to the modulation part 322.

The modulation part 322 converts data received from the encoding part 321 into a modulated signal on the basis of the information sent from the scheduling part 214. Then, the modulation part 322 outputs the modulated signal to the antenna mapping part 323.

The antenna mapping part 323 uses information received from the scheduling part 214 and the estimated channel response received from the channel estimation part 327, to calculate a weighting coefficient for multiplying the modulated signal. The antenna mapping part 323 multiplies the modulated signal received from the modulation part 322 by the calculated weighting coefficient, adds the spatially multiplexed signal after multiplication by the weighting coefficient, and outputs to the resource mapping part 324.

The resource mapping part 324 maps the signal received from the antenna mapping part 323 to radio resources on the basis of the information received from the scheduling part 214. Then, the resource mapping part 324 outputs the signal after the resource mapping to the IFFT part 325.

The IFFT part 325 performs an Inverse Fast Fourier Transform (IFFT) of the signal received from the resource mapping part 324 and outputs the signal after the IFFT to the RF processing part 330. It is to be noted that cyclic prefix is added between the IFFT part 325 and the RF processing part 330 (not shown in the drawings).

The RF processing part 330 converts a baseband signal received from the IFFT part 325 into a radio frequency signal and transmits the radio frequency signal via the antenna 340.

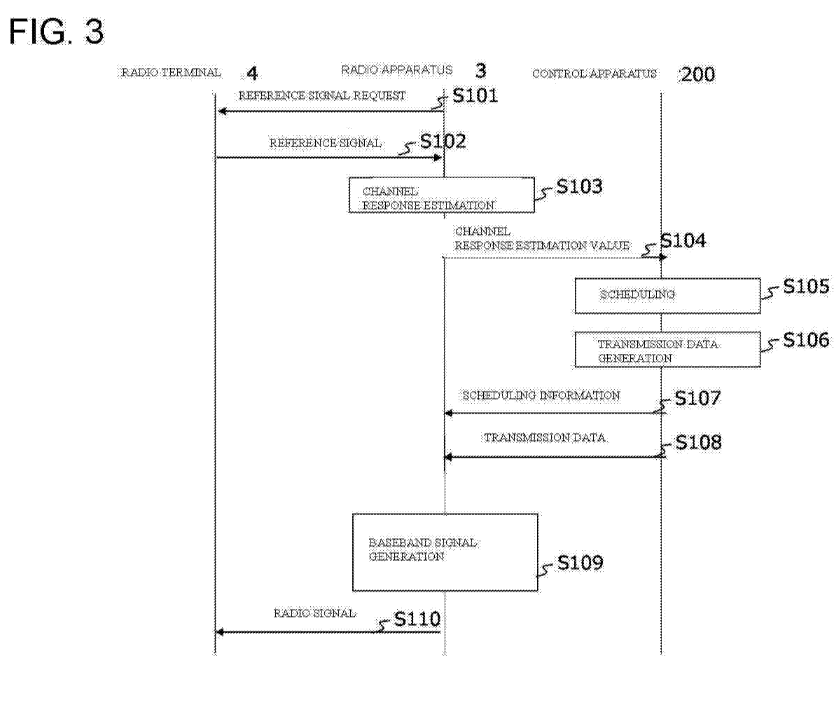

As shown in FIG. 3, the radio apparatus 3 in the present exemplary embodiment performs the following operations S101 to S110.

First, the radio apparatus 3 transmits a reference signal request to the radio terminal 4 (operation S101). The radio apparatus 3 receives the reference signal from the radio terminal 4 (operation S102). In the radio apparatus 3, the channel estimation part 327 estimates a channel response (transfer function, impulse response, or the like) of a channel between the radio apparatus 3 and the radio terminal 4 (operation S103). The radio apparatus 3 sends the estimated channel response to the control apparatus 200 (operation S104). In this regard, the radio apparatus 3 does not need to send the estimated channel responses of all radio terminals. For example, when the radio apparatus 3 sends the estimated channel responses of radio terminals not communicating with the radio apparatus 3, the radio apparatus 3 may limit the number of the estimated channel responses to be send on the basis of the gain of the channel responses. The control apparatus 200 may designate radio terminals whose estimated channel responses should be send, and the radio apparatus 3 may limit the number of the estimated channel responses to be send on the basis of the designation.

The scheduling part 214 of the control apparatus 200 allocates radio resources and modulation and coding schemes (MCS) to radio terminals using the estimated channel responses sent from the radio apparatus 3 (operation S105). The central baseband processing part 210 of the control apparatus 200 performs buffering of user data after compression and encryption, performs dividing/combining of the buffered data on the basis of a request from the scheduling part 214, and generates transmission data (operation S106). The control apparatus 200 sends scheduling results (the combination of terminals, number of layers, MCS, etc.) of operation S105 to the radio apparatus 3 (operation S107). In addition, the control apparatus 200 multiplexes the transmission data generated in operation S106 and control information according to a request from the scheduling part 214 and sends the multiplexed data and information to the radio apparatus 3 (operation S108).

The remote baseband processing part 320 of the radio apparatus 3 performs encoding, modulation, weight generation, mapping and the like for the transmitted data sent in operation S108 on the basis of the scheduling information sent in operation S107 and generates a baseband signal (operation S109). The RF processing part 330 of the radio apparatus 3 generates a radio frequency signal from the baseband signal generated in operation S109, and transmits the radio frequency signal via the antenna 340 (operation S110).

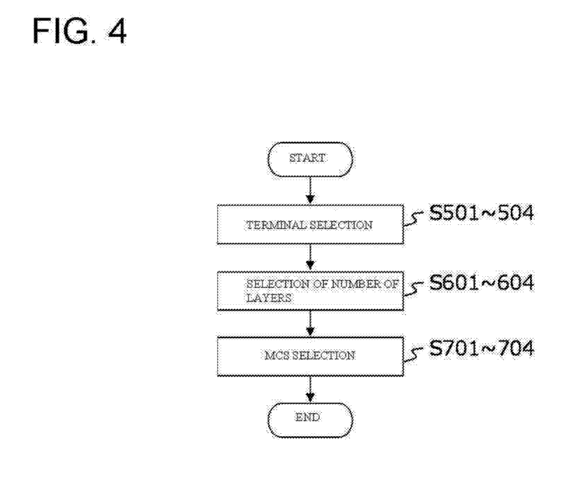

A description is given of detailed operations of scheduling of operation S105 in the present exemplary embodiment, as shown in FIG. 4 to FIG. 7.

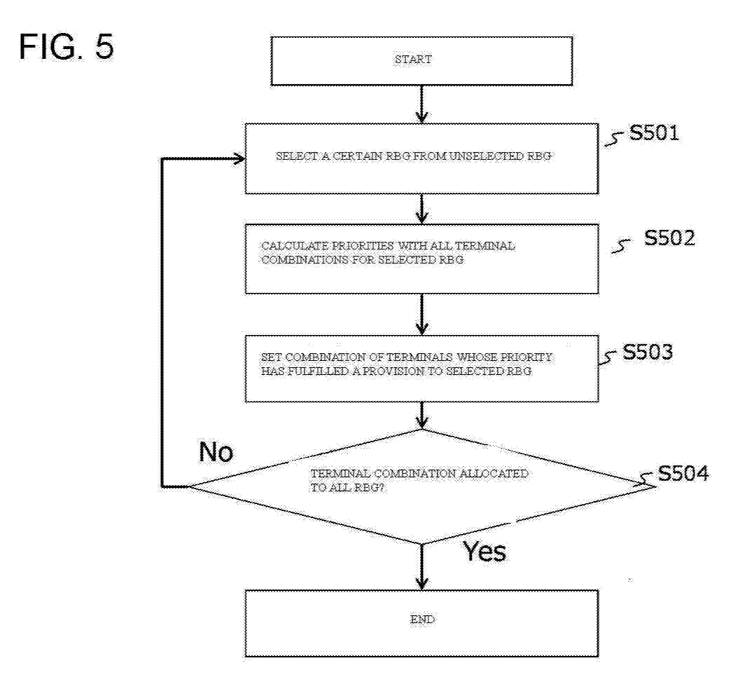

The scheduling part 214 in the present exemplary embodiment first selects radio terminals for communication from among the radio terminals (operations S501-S504). A description is given concerning selection of terminal, as shown in FIG. 5

First, the scheduling part 214 selects a certain RBG (Resource Block Group) from selectable RBGs (operation S501). Although a RB (Resource Block) in LTE (Long Term Evolution) is defined as consisting of 12 consecutive subcarriers, which are spaced 15 kHz apart from each other, a RB assumed in the present disclosure is not limited to this definition.

Next, the scheduling part 214 calculates priorities for all terminal combinations (operation S502). It is to be noted that the scheduling part 214 may calculate channel correlation between terminals and the priorities for only a few terminal combination with the low correlation. The scheduling part 214 may calculate the selection frequency of respective radio terminals and the priorities for only a few radio terminals with the low selection frequency. A method of calculating the priorities is described later.

The scheduling part 214 selects a terminal combination on the basis of the calculated priorities and allocates the selected RBG to terminals included in the selected combination (operation S503). In one example, the scheduling part 214 selects the terminal combination with the maximum priorities. In another example, the scheduling part 214 selects the terminal combination which has the maximum priorities under the condition that respective terminals satisfy a minimum rate. Alternatively, the scheduling part 214 selects the terminal combination using a preset threshold.

If all RBGs are allocated to terminals, proceed to the following step (operation S504).

The scheduling part 214 selects the number of layers for the respective radio terminals selected in operations S501-S504 (operations S601-S604). Here “the number of layers” indicates the number of modulated signals multiplied by different weigh coefficients in the antenna mapping 323, that is, the number of spatially multiplexed modulated signals. It is assumed that the number of layers is the same as the number of codewords, which are blocks to be encoded, for simplifying the following description. It is to be noted that the selection of terminals and the number of layers may be performed simultaneously.

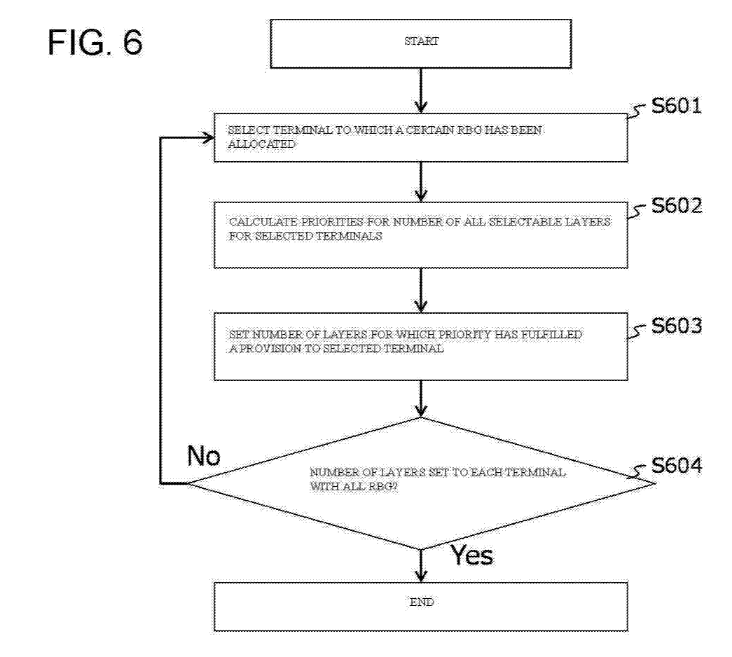

A description is given concerning the selection of the number of layers, as shown in FIG. 6.

First, the scheduling part 214 selects a terminal from among terminals to which any RBGs are allocated (operation S601). The scheduling part 214 calculates priorities changing the number of layers for the selected terminal (operation S602). The scheduling part 214 selects the number of layers for the selected terminal on the basis of the calculated priorities (operation S603). In one example, the scheduling part 214 selects the terminal combination with the maximum priorities. In another example, the scheduling part 214 selects the terminal combination which has the maximum priorities under the condition that respective terminals satisfy a minimum rate. Alternatively, the scheduling part 214 selects the terminal combination using a preset threshold.

If the number of layers are selected to all terminals to which any RBGs are allocated, proceed to the following step (operation S604).

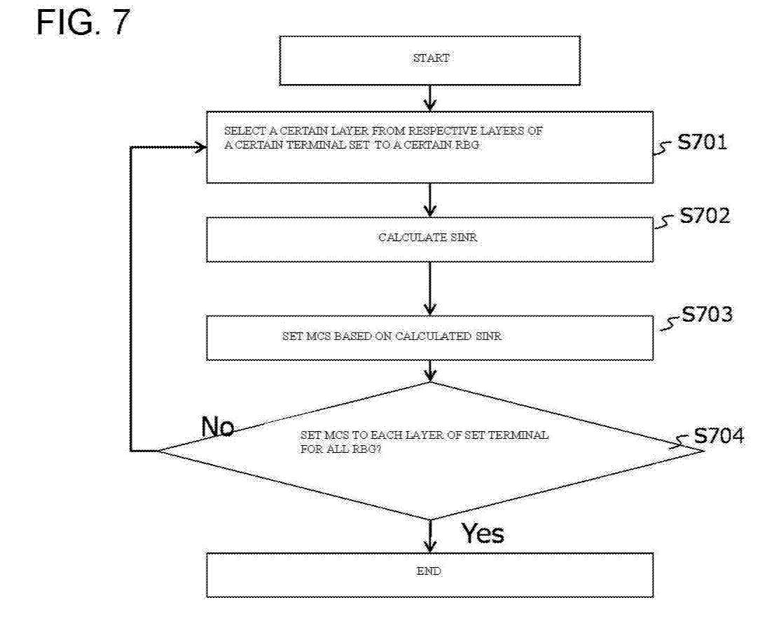

Finally, as shown in FIG. 7, the scheduling part 214 selects MCS corresponding to respective layers of respective terminals for the respective RBGs (operation S701-S704). First, the scheduling part 214 selects a layer from the respective layers of a certain terminal set in a certain RBG (operation S701).

The scheduling part 214 calculates received SINR for the selected layer (operation S702). In this regard, there is no need to limit the number of calculated SINR to 1, and a SINR may be calculated for each of a plurality of RBs included in a RBG. It is to be noted that a method of calculating SINR is described later.

The scheduling part 214 selects an MCS on the basis of the calculated SINR (operation S703). For example, the scheduling part 214 may set a value of SINR required for satisfying the prescribed quality (e.g. packet error rate of 0.1) for each MCS and select the maximum MCS under the condition that the average value of the calculated SINR is higher than the set value of SINR. It is to be noted that when the average value of the calculated SINR and the set value of SINR are compared an offset value may be added to the average value. For example, the offset value may be a constant value or be successively changed in accordance with the success or failure of communication.

If MCS is set for all layers of the set terminal for all RBs, proceed to the next step (operation S704).

When allocating radio resources, values representing priority are often used. High priority indicates an optimal combination among the set. Priority Mₖ, which is used in allocating resources, is calculated by, for example, Max-C/I method or PF (Proportional Fairness) method.

For the Max-C/I method, the scheduling part 124 estimates received SINRs for radio terminals included in a set Uₛ(n) of selected terminals and the radio terminal with terminal number k, converts the estimated SINRs into instantaneous rates by the Shannon theorem, and set the sum of the instantaneous rates to Mₖ.

For the PF method, the scheduling part 124 uses the ratio of an instantaneous rate to an average rate for resource allocation. The scheduling part 124 set the sum of the ratios to Mₖ instead of the sum of the instantaneous rates.

It is to be noted that metric calculation criteria may change according to the number of spatially multiplexed terminals. In order to select a combination of terminals with low correlation, the reciprocal of the channel correlation between terminals may be used as the metric.

As mentioned above, received SINR is required for calculating the priorities. Three examples of SINR calculation methods are described below.

In the first example, the scheduling part 124 generates transmit weights (weight coefficients by which modulated signals are multiplied) and receive weights (weight coefficients by which received signals are multiplied) using channel response. Then, the scheduling part 124 estimates SINR using them.

In the second example, the scheduling part 124 estimates SINR using channel response vectors which are generated by performing the matrix operation of channel response and are received from the radio apparatus 3.

In the third example, the scheduling part 124 estimates SINR using correlation between terminals which are calculated from channel response vector received from the radio apparatus 3. These examples are expressed in formulas (1), (3) and (6) shown as follows.

First, a description is given of a method using weight, which is the first example of the method of calculating received SINR. As an example, a case is considered where SINR of l-th layer of k-th radio terminal is estimated. The number of antennas the radio terminal 4 is provided with is N_{R}, and the number of antennas the radio apparatus 3 is provided with is N_{T} (greater than or equal to N_{R}). Hₖ is the N_{R}×N_{T} channel response matrix whose elements are estimated channel responses between the radio apparatus 3 and the k-th radio terminal and are received from the radio apparatus 3. An N_{T} dimension transmit weight vector with regard to the l-th layer of the k-th radio terminal is w_{Tx,k,l}, and an N_{R} dimension receive weight vector is w_{Rx,k,l}. Transmission power is P_{k,l}, and other-cell interference power is σ_{I}²(k,l). The set of terminals selected by the scheduling part 124 is Uₛ, and the noise power is σn₂. Received SINRγ_{k,l} of the l-th layer of the k-th radio terminal is estimated by the following formula (1). In this regard, ^{H} is a Hermitian transpose.

$$\begin{matrix}Formula 1 & \\ {γ}_{k , l} = \frac{{\vert {w}_{Rx , k , l}^{H} {H}_{k} {w}_{Tx , k , l} \vert}^{2} {P}_{k , l}}{\begin{matrix}{\sum }_{{( {k}^{′} , {l}^{′} ) \neq ( k , l )}_{{k}^{′} ∈ {⋃}_{s}}} {\vert {w}_{Rx , k , l}^{H} {H}_{k} {w}_{Tx , {k}^{′} , {l}^{′}} \vert}^{2} {P}_{{k}^{′} , {l}^{′}} + {σ}_{I}^{2} ( k , l ) + \\ {‖ {w}_{Rx , k , l} ‖}^{2} {σ}_{n}^{2}\end{matrix}} & Formula ( 1 )\end{matrix}$$

Next, a description of given of a method of calculating a parameter used in formula (1), transmit weight vector w_{Tx,k,l}. The transmit weight vector w_{Tx,k,l} is generated by the scheduling part 214 according to a prescribed criterion using Hₖ. Example of criteria include MRT (Maximum Ratio Transmission), ZF (Zero Forcing), and SLNR (Signal to Leakage plus Noise Ratio).

Here, a generation method according to the ZF criterion is given as an example. K′ radio terminals 4 from terminal number 1 to K′ are selected with regard to an RBG as SINR estimation target, and (K′N_{R})×N_{T} channel response matrix H is obtained by combining the channel response matrices of K′ radio terminals 4, that is, H^{H}=(H₁^{H} . . . H_{K′}^{H}). N_{T}×(K′NR) transmit weight matrix W_{Tx}, which consists of transmit weight vectors of respective radio terminals, is obtained by W_{Tx}=H^{H}(H·H^{H})⁻¹.

This W_{Tx} includes N_{R} transmit weight vectors for each of K′ radio terminals. A transmit weight vector whose product with the channel response matrix Hₖ is the l-th largest among the transmit weight vectors of the k-th radio terminal included in W_{Tx} may be selected as the transmit weight vector w_{Tx,k,l} of the l-th layer of the k-th radio terminal.

Next, a method of calculating receive weight vector w_{Rx,k,l}, which is a parameter used in formula (1), is described below. The receive weight vector w_{Rx,k,l} is generated according to a prescribed criterion by using Hₖ and w_{Tx,k,l}. When an MRC (Maximum Ratio Combining) criterion is used as an example, the receive weight vector w_{Rx,k,l} is obtained by the following formula (2).

$$\begin{matrix}Formula 2 & \\ {W}_{{R}_{x , k , l}} = {H}_{k} {w}_{{T}_{x , k , l}} & Formula ( 2 )\end{matrix}$$

A method of calculating a parameter used in formula (1), transmission power P_{k,l}, is described below. As examples of a method of setting the transmission power P_{k,l}, there are a method of allocating the same power for each layer of the selected K′ radio terminals, a method of allocating a value corresponding to the magnitude of the product of the transmit weight vector and the channel response matrix under the condition that the total power of all layers is constant and so on.

It is to be noted that the first item of the denominator on the right side in formula (1) is interference power given to the k-th radio terminal by signals excluding the signal of the l-th layer of the k-th radio terminal. The magnitude of this interference power depends on a generation criterion of the transmit weight vector. For example, the interference power is 0 when generating with the ZF criterion, and then, it is possible to ignore the first item of the denominator on the right side in the calculation of formula (1).

Next, as the second example of a method of calculating received SINR, a description is given of a method using a channel response vector for each layer. As an example, received SINRγ_{k,l} of the l-th layer of the k-th radio terminal are estimated according to the following formula (3) using the channel response vector g_{k,l} of the l-th layer of the k-th radio terminal. In this regard, ^{T} represents a transposition.

$$\begin{matrix}Formula 3 & \\ {γ}_{k , l} = \frac{{\vert {g}_{k , l}^{T} {w}_{Tx , k , l} \vert}^{2} {P}_{k , l}}{{\sum }_{{( {k}^{′} , {l}^{′} ) \neq ( k , l )}_{{k}^{′} ∈ {⋃}_{s}}} {\vert {g}_{k , l}^{T} {w}_{Tx , {k}^{′} , {l}^{′}} \vert}^{2} {P}_{{k}^{′} , {l}^{′}} + {σ}_{I}^{2} ( k , l ) + {σ}_{n}^{2}} & Formula ( 3 )\end{matrix}$$

A method of calculating a parameter used in formula (3), channel response vector g_{k,l} of each layer, is described below. An N_{T} dimension channel response vector g_{k,l} of the l-th layer of the k-th radio terminal is represented by the following formula (4).

Formula 4

g_{k,l}=\sqrt{λ_{k,l}}v_{k,l}* Formula(4)

In this regard, * represents a complex conjugate. Because v_{k,l} forms an orthogonal basis, g_{k,l} generated according to formula (4) is mutually orthogonal between layers. That is, the inner product of g_{k,l} and g_{k,l′} (l not equal to l′) is 0. In order to obtain the channel response vector of each layer, a singular value decomposition or eigenvalue decomposition is performed on the channel response matrix, and λ and v are generated.

A method of calculating parameters λ and v used in formula (4) by singular value decomposition is described below. N_{R}×N_{T} channel response matrix Hₖ that has elements of estimated values of the channel response between the radio apparatus and the k-th radio terminal, is represented by the following formula (5).

$$\begin{matrix} Formula 5 & \\ \begin{matrix}{H}_{k} = {U}_{k} {Σ}_{k} {V}_{k}^{H} \\ = ( \begin{matrix}{u}_{k , 1} & … & {u}_{k , {N}_{R}}\end{matrix} ) ( \begin{matrix}\sqrt{{λ}_{k , 1}} & 0 & … & 0 \\ 0 & ⋱ & ⋱ & ⋮ \\ 0 & 0 & \sqrt{{λ}_{k , {N}_{R}}} & 0\end{matrix} ) ( \begin{matrix}{v}_{k , 1}^{H} \\ ⋮ \\ {v}_{k , {N}_{T}}^{H}\end{matrix} )\end{matrix} & Formula ( 5 )\end{matrix}$$

In this regard, Uₖ is an N_{R}×N_{R} partary matrix having the left singular vector u_{k,l} (l=1, . . . , N_{R}) in a column vector. Vₖ is an N_{T}×N_{T} partary matrix having the right singular vector v_{k,l} (l=1, . . . , N_{T}) in a column vector. Σ is an N_{R}×N_{T} matrix having Hₖ singular values (square root of eigenvalue λ_{k,l} (l=1, . . . , N_{R})) as diagonal elements, and non-diagonal elements of 0. It is to be noted that subscripts of singular values (and eigenvalues) are numbered in descending order of their values.

Next, a case where eigenvalue decomposition is used is described below. Eigenvalue decomposition is applied to the N_{T}×N_{T} matrix Hₖ^{H}Hₖ, to calculate eigenvalue λ_{k,l} and eigenvector v_{k,l}. It is to be noted that before performing the singular value decomposition or the eigenvalue decomposition, averaging in time and frequency directions may be performed for Hₖ or Hₖ^{H}Hₖ.

As the third example of a method of calculating a received SINR, a method using channel gain and correlation (Channel Gain/Channel Correlation) is described below. As an example, a received signal SINRγ_{k,l} of the l-th layer of the k-th radio terminal is estimated according to formula (6) using the channel response vector g_{k,l} of the l-th layer of the k-th radio terminal and coefficients α_{k,l} indicating channel gain. The method of generating the channel response vector g_{k,l} of each layer is similar to the method described in formula (5) and is thus omitted.

$$\begin{matrix}Formula 6 & \\ {γ}_{k , l} = \frac{{α}_{k , l} {‖ {g}_{k , l} ‖}^{2} {P}_{k , l}}{{σ}_{I}^{2} ( k , l ) + {σ}_{n}^{2}} & Formula ( 6 )\end{matrix}$$

A description is given concerning a method of generating a parameter used in formula (6), coefficient α_{k,l} indicating channel gain. As examples, the calculation method is described for two cases: the case of using the ZF criterion and the case of spatially multiplexing many layers.

First, since a transmit weight vector is generated such that there is no mutual interference of signals with destination of multiple radio terminals that are spatially multiplexed in the case of the ZF criterion, the gain of a desired signal deteriorates only for this amount. α_{k,l} is gain normalized with this effect added and is calculated according to the following formula (7).

$$\begin{matrix} Formula 7 & \\ {α}_{k , l} = 1 - \frac{{\sum }_{{( {k}^{′} , {l}^{′} ) \neq ( k , l )}_{{k}^{′} ∈ {⋃}_{s}}} {\vert {ρ}_{( k , l ) ( {k}^{′} , {l}^{′} )} \vert}^{2} - 2 \text{?} Re [ {ρ}_{( k , l ) ( {k}^{′} , {l}^{′} )} ρ \text{?} ρ \text{?} ]}{\begin{matrix}1 - 2 \text{?} {\vert ρ \text{?} \vert}^{2} - {\sum }_{{( {k}^{′} , {l}^{′} ) \neq ( k , l )}_{{k}^{′} ∈ {⋃}_{s}}} {\vert {ρ}_{( k , l ) ( {k}^{′} , {l}^{′} )} \vert}^{2} + \\ 2 \text{?} Re [ {ρ}_{( k , l ) ( {k}^{′} , {l}^{′} )} ρ \text{?} ρ \text{?} ]\end{matrix}} \\ \text{?} \text{indicates text missing or illegible when filed} & Formula ( 7 )\end{matrix}$$

A method of calculating parameters used for deriving formula (6), correlation ρ_{(k,l) (k′,l′)} of channels between the l-th layer of the k-th radio terminal and the l′-th layer of the k′-th radio terminal, is described below. Channel response vector g_{k,l} of the l-th layer of the k-th radio terminal and channel response vector g_{k′,l′} of the l′-th layer of the k′-th radio terminal are used to perform the calculation according to formula (8).

$$\begin{matrix}Formula 8 & \\ {ρ}_{( k , l ) ( {k}^{′} , {l}^{′} )} = \frac{{g}_{k , l}^{H} {g}_{{k}^{′} , {l}^{′}}}{‖ {g}_{k , l} ‖ \cdot ‖ {g}_{{k}^{′} , {l}^{′}} ‖} & Formula ( 8 )\end{matrix}$$

A method of deriving α_{k,l} of formula (7) is described below. When K′ radio terminals 4 from terminal numbers 1 to K′ are selected, L×N_{T} channel response matrix G with channel response matrices for each radio terminal combined is represented as in the following formula (9).

$$\begin{matrix} Formula 9 & \\ G = ( \begin{matrix}{g}_{1 , 1}^{T} \\ ⋮ \\ {g}_{{K}^{′} , L ( {K}^{′} )}^{T}\end{matrix} ) = ( \begin{matrix}‖ {g}_{1 , 1} ‖ & & 0 \\ & ⋱ & \\ 0 & & ‖ {g}_{{K}^{′} , L ( {K}^{′} )} ‖\end{matrix} ) ( \begin{matrix}{g}_{1 , 1}^{T} / ‖ {g}_{1 , 1} ‖ \\ ⋮ \\ {g}_{{K}^{′} , L ( {K}^{′} )}^{T} / ‖ {g}_{{K}^{′} , L ( {K}^{′} )} ‖\end{matrix} ) = {DG}^{′} & Formula ( 9 )\end{matrix}$$

As in formula (9), G is represented as the product of an L×L matrix D and an L×N_{T} matrix G′. D has zeros in non-diagonal elements and the norm of channel response vector of each layer in each diagonal element, and G′ consists of channel response vector of each layer that have been normalized. An N_{T}×L transmit weight matrix W_{Tx} when using the ZF criterion is represented as in the following formula (10).

Formula 10

W_{Tx}=G^{H}(GG^{H})⁻¹=G′^{H}(G′G′^{H})⁻¹D⁻¹ Formula 10)

The product of G′ and G′^{H} in formula (10) has ones in diagonal elements and channel correlation between two layers which is calculated from formula (8) in non-diagonal element. An inverse matrix of the product of G′ and G′^{H} can be obtained using a cofactor matrix, and elements of this inverse matrix are represented using correlations of channels between layers. The numerator on the right side of formula (3) is calculated using the transmit weight vector derived from formula (10), and by comparing with the numerator on the right side of formula (6), α_{k,l} of formula (7) can be derived.

In this regard, fourth order items and above of the correlation of the channels between layers in formula (7) are disregarded. The calculation of α_{k,l} is not limited to formula (7), and fourth order items and above in the channel correlation between layers may be considered, and third order items may be disregarded.

Next, in a case where there are many layers (number of signals) that perform spatial multiplexing, accuracy deteriorates in estimation of α_{k,l} using formula (7) by disregarding high order items of channel correlations between layers. In particular when the value of the denominator of the second item on the right side of formula (7) is small, the value of α_{k,l} may deviate largely from the true value. Therefore, α_{k,l} may be derived according to the following formula (11).

$$\begin{matrix}Formula 11 & \\ {α}_{k , l} = 1 - {\sum }_{{( {k}^{′} , {l}^{′} ) \neq ( k , l )}_{{k}^{′} ∈ {⋃}_{s}}} {\vert {ρ}_{( k , l ) ( {k}^{′} , {l}^{′} )} \vert}^{2} & Formula ( 11 )\end{matrix}$$

In comparison with a case using formula (7), while estimation accuracy decreases when there are few layers, it is possible to avoid a large deterioration in estimation accuracy when there is a large number of layers.

It is to be noted that while the coefficient of each item is 1, there is no limitation to this. Third order items and above of the correlation of the channels between layers may be considered.

In a case of using weights in a first example in the method of calculating the received SINR, 3 examples are cited as a method of calculating σ_{I}²(k,l) indicating other-cell interference power.

In the first example, use is made of channel response between the radio apparatus that is an interference source and the k-th radio terminal, and transmit weight vector (matrix) where the radio apparatus that is an interference source is applied.

In the second example, use is made of a channel quality indicator (CQI) reported in the scheduling part 214 via the radio apparatus 3 from the radio terminal 4.

In the third example, use is made of Reference Signal Received Power (RSRP) for each cell reported to the control apparatus 2 via the radio apparatus 3 from the radio terminal 4. These are respectively expressed in formulas (12)-(14) shown as follows.

First, a description is given concerning a method of calculating σ_{I}²(k,l) indicating cell interference power using the transmit weight vector, which is a first example. With the radio apparatus with which the k-th terminal communicates having the number j, the other radio apparatus that is an interference source having the number j′, the set of radio terminals selected by the j′-th radio apparatus as U_{s,j′}, the channel response matrix between the j′-th radio apparatus and the k-th radio apparatus as H_{j′,k}, the transmit weight vector corresponding to the l′-th layer of the k′-th radio terminal communicating with the j′-th radio apparatus as w_{Tx,j′k′,l′}, and transmission power as P_{j′,k′,l′}, then σ_{I}²(k,l) is calculated according to the following formula (12).

$$\begin{matrix}Formula 12 & \\ {σ}_{I}^{2} ( k , l ) = {\sum }_{{j}^{′} \neq j} {\sum }_{{( {k}^{′} , {l}^{′} )}_{{k}^{′} ∈ {⋃}_{s , f}}} {\vert {w}_{Rx , k , l}^{H} {H}_{{j}^{′} , k} {w}_{Tx , {j}^{′} , {k}^{′} , {l}^{′}} \vert}^{2} {P}_{{j}^{′} , {k}^{′} , {l}^{′}} & Formula ( 12 )\end{matrix}$$

Continuing, as a second example a description is given concerning a method of calculating σ_{I}²(k,l) indicating cell interference power using CQI. The radio terminal 4 measures SINR using a known signal (reference signal) transmitted by the radio apparatus 3, compares this with an SINR threshold set for each CQI number, determines CQI number, and reports this number to the scheduling part 214 via the radio apparatus 3. With CQI reported by the k-th radio terminal as CQIₖ, a function for converting CQI to SINR as f( ), a correction coefficient of other-cell interference power as μ, then σ_{I}²(k,l) is calculated according to the following formula (13). It is to be noted that the value of the correction coefficient μ may be constant, or may be adaptively changed in accordance with success or failure of communication.

$$\begin{matrix} Formula 13 & \\ {σ}_{I}^{2} ( k , l ) = {‖ {w}_{Rx , k , l} ‖}^{2} \{ \frac{μ {\vert {w}_{Rx , k , l}^{H} {H}_{k} {w}_{Tx , k , l} \vert}^{2} {\sum }_{( {k}^{′} , {l}^{′} ) , {k}^{′} ∈ {⋃}_{s}} {P}_{{k}^{′} , {l}^{′}}}{f ( {CQI}_{k} )} - {σ}_{n}^{2} \} & Formula ( 13 )\end{matrix}$$

As a third example, a description is given concerning a method of calculating σ_{I}²(k,l) indicating cell interference power using RSRP. With the radio apparatus with which the k-th radio terminal communicates having number j, RSRP of the j-th radio apparatus with respect to the k-th radio terminal being RSRPⱼ, then σ_{I}²(k,l) is calculated according to the following formulas (14) and (15).

$$\begin{matrix} Formula 14 & \\ {σ}_{I}^{2} ( k , l ) = {‖ {w}_{Rx , k , l} ‖}^{2} \{ μ {\vert {w}_{Rx , k , l}^{H} {H}_{k} {w}_{Tx , k , l} \vert}^{2} {\sum }_{( {k}^{′} , {l}^{′} ) , {k}^{′} ∈ {⋃}_{s}} {P}_{{k}^{′} , {l}^{′}} {\sum }_{{j}^{′} \neq j} q ( j , {j}^{′} ) \} & Formula ( 14 ) \\ Formula 15 & \\ q ( j , {j}^{′} ) = {10}^{( {RSRP}_{{j}^{′}} - {RSRP}_{j} ) / 10} & Formula ( 15 )\end{matrix}$$

In a case of using another SINR calculation method, a description is given of a method of calculating σ_{I}²(k,l) indicating other-cell interference power. With regard to the formula for calculating interference power indicated in formulas (12), (13) and (14), the configuration can be changed as appropriate according to the method of calculating SINR. For example, it is possible to make modifications as in the following calculation formulas (16), (17), (18), (19), (23) and (24).

First, when estimating SINR, in a case of using an orthogonal channel response for each layer, a description is given of a method of calculating σ_{I}²(k,l) indicating other-cell interference power.

As a first example, a description is given of a case of using a transmit weight vector in estimating σ_{I}²(k,l) indicating other-cell interference power. With the radio apparatus with which the k-th terminal communicates having the number j, the other radio apparatus that is an interference source having the number j′, the set of radio terminals selected by the j′-th radio apparatus as U_{s,j′}, the channel response vector between the j′-th radio apparatus and the l-th layer of the k-th radio apparatus as g_{j′,k,l}, the transmit weight vector corresponding to the l′-th layer of the k′-th radio terminal communicating with the j′-th radio apparatus as w_{Tx,j′,k′,l′}, and transmission power as P_{j′,k′,l′}, then σ_{I}²(k,l) is calculated according to the following formula (16).

$$\begin{matrix}Formula 16 & \\ {σ}_{I}^{2} ( k , l ) = {\sum }_{{j}^{′} \neq j} {\sum }_{{( {k}^{′} , {l}^{′} )}_{{k}^{′} ∈ {⋃}_{s , f}}} {\vert {g}_{{j}^{′} , k , l}^{T} {w}_{Tx , {j}^{′} , {k}^{′} , {l}^{′}} \vert}^{2} {P}_{{j}^{′} , {k}^{′} , {l}^{′}} & Formula ( 16 )\end{matrix}$$

As a second example, a description is given of a case of using CQI in estimating σ_{I}²(k,l) indicating other-cell interference power. With CQI reported by the k-th radio terminal as CQIₖ, a function for converting CQI to SINR as f( ), a correction coefficient for other-cell interference power as μ, then σ_{I}²(k,l) is calculated according to the following formula (17).

$$\begin{matrix}Formula 17 & \\ {σ}_{I}^{2} ( k , l ) = \frac{μ {\vert {g}_{k , l}^{T} {w}_{Tx , k , l} \vert}^{2} {\sum }_{( {k}^{′} , {l}^{′} ) , {k}^{′} ∈ {⋃}_{s}} {P}_{{k}^{′} , {l}^{′}}}{f ( {CQI}_{k} )} - {σ}_{n}^{2} & Formula ( 17 )\end{matrix}$$

It is to be noted that the value of the correction coefficient μ may be constant, or may be adaptively changed in accordance with the success or failure of communication.

As a third example, a description is given of a case of using RSRP in estimating σ_{I}²(k,l) that indicates other-cell interference power. With the radio apparatus with which the k-th radio terminal communicates having number j, and RSRP of the j-th radio apparatus with respect to the k-th radio terminal being RSRPⱼ, then σ_{I}²(k,l) is calculated according to the following formula (18).

$$\begin{matrix}Formula 18 & \\ {σ}_{I}^{2} ( k , l ) = μ {\vert {g}_{k , l}^{T} {w}_{Tx , k , l} \vert}^{2} {\sum }_{( {k}^{′} , {l}^{′} ) , {k}^{′} ∈ {⋃}_{s}} {P}_{{k}^{′} , {l}^{′}} {\sum }_{{j}^{′} \neq j} q ( j , {j}^{′} ) & Formula ( 18 )\end{matrix}$$

When estimating SINR, in a case of using correlation with channel gain, a description is given of a method of calculating σ_{I}²(k,l) that indicates other-cell interference power.

As a first example, a description is given of a case of using a transmit weight vector in estimating σ_{I}²(k,l) indicating other-cell interference power. With the radio apparatus with which the k-th terminal communicates having the number j, another radio apparatus that is an interference source having the number j′, the set of radio terminals selected by the j′-th radio apparatus as U_{s,j′}, the channel response vector between the j′-th radio apparatus and the l-th layer of the k-th radio apparatus as g_{j′,k,l}, the transmission power corresponding to the l′-th layer of the k′-th radio terminal that communicates with the j′-th radio apparatus as P_{j′,k′,l′}, then σ_{I}²(k,l) is calculated according to the following formula (19).

$$\begin{matrix}Formula 19 & \\ {σ}_{I}^{2} ( k , l ) = {\sum }_{{j}^{′} \neq j} {\sum }_{{( {k}^{′} , {l}^{′} )}_{{k}^{′} ∈ {⋃}_{s , {j}^{′}}}} {β}_{{j}^{′} , ( k , l ) ( {k}^{′} , {l}^{′} )} {\vert {g}_{{j}^{′} , k , l} \vert}^{2} {P}_{{j}^{′} , {k}^{′} , {l}^{′}} & Formula ( 19 )\end{matrix}$$

Parameters βj′,(k,l)(k′,l′) included in the abovementioned formula are calculated according to the following formula (20).

$$\begin{matrix} Formula 20 & \\ {β}_{{j}^{′} , ( k , l ) ( {k}^{′} , {l}^{′} )} = \frac{{\vert {ρ}_{{j}^{′} ( k , l ) ( {k}^{′} , {l}^{′} )} \vert}^{2} - 2 \text{?} Re [ {ρ}_{{j}^{′} , ( k , l ) ( {k}^{′} , {l}^{′} )} ρ \text{?} ρ \text{?} ]}{1 - 2 \text{?} {\vert ρ \text{?} \vert}^{2} - \text{?} {\vert ρ \text{?} \vert}^{2} + 2 \text{?} Re [ \text{?} ]} \\ \text{?} \text{indicates text missing or illegible when filed} & Formula ( 20 )\end{matrix}$$

It is to be noted that in formula (20), fourth order items and above of the correlation of the channels between layers are disregarded. The calculation formula of ββ_{j′,(k,l)(k′,l′)} is not limited to formula (20), and fourth order items and above in the correlation of the channels between layers may be considered, and third order items may be disregarded.

Correlations ρ_{j′,(k,l)(k′,l′)} of the channels between the l-th layer of the k-th radio terminal and the l′-th layer of the k′-th radio terminal, with regard to the j′-th radio apparatus, are calculated according the following formula (21), using the channel response vector g_{j′,k,l} of the l-th layer of the k-th radio terminal and the channel response vector g_{j′,k′,l′} of the l′-th layer of the k′-th radio terminal.

$$\begin{matrix}Formula 21 & \\ {ρ}_{{j}^{′} , ( k , l ) ( {k}^{′} , {l}^{′} )} = \frac{{g}_{{j}^{′} , k , l}^{H} {g}_{{j}^{′} , {k}^{′} , {l}^{′}}}{‖ {g}_{{j}^{′} , k , l} ‖ \cdot ‖ {g}_{{j}^{′} , {k}^{′} , {l}^{′}} ‖} & Formula ( 21 )\end{matrix}$$

In a case where there are many layers (number of signals) where spatial multiplexing is performed, by disregarding high order items of correlations of channels between layers, the value of β_{j′,(k,l)(k′,l′)} derived by formula (20) may deviate largely from the true value. Therefore, β_{j′,(k,l)(k′,l′)} may be derived according to the following formula (22).

Formula 22

β_{j′,(k,l)(k′,l′)}=|ρ_{j′,(k,l)(k′,l′)}|² Formula (22)

It is to be noted that while the coefficient of each item is 1, there is no limitation to this. Third order items and above of the correlation of the channels between layers may be considered.

As a second example, a description is given of a case of using CQI in estimating σ_{I}²(k,l) that indicates other-cell interference power. With CQI reported by the k-th radio terminal as CQIₖ, a function for converting CQI to SINR as f( ), a correction coefficient of other-cell interference power as μ, then σ_{I}²(k,l) is calculated according to the following formula (23).

Formula 23

$${σ}_{I}^{2} ( k , l ) = \frac{{μα}_{k , l} {\vert {g}_{k , l} \vert}^{2} {\sum }_{( {k}^{′} , {l}^{′} ) , {k}^{′} ∈ {⋃}_{s}} {P}_{{k}^{′} , {l}^{′}}}{f ( {CQI}_{k} )} - {σ}_{n}^{2} \qquad Formula ( 23 )$$

It is to be noted that the value of the correction coefficient μ may be constant, or may be adaptively changed in accordance with the success or failure of communication.

As a third example, a description is given of a case of using RSRP in estimating σ_{I}²(k,l) indicating other-cell interference power. With the radio apparatus with which the k-th radio terminal communicates having number j, and RSRP of the j-th radio apparatus with respect to the k-th radio terminal being RSRPⱼ, then σ_{I}²(k,l) is calculated according to the following formula (24).

$$\begin{matrix}Formula 24 & \\ {σ}_{I}^{2} ( k , l ) = {μα}_{k , l} {\vert {g}_{k , l}^{T} \vert}^{2} {\sum }_{( {k}^{′} , {l}^{′} ) , {k}^{′} ∈ {⋃}_{s}} {P}_{{k}^{′} , {l}^{′}} {\sum }_{{j}^{′} \neq j} q ( j , {j}^{′} ) & Formula ( 24 )\end{matrix}$$

A description is given of a method of calculating a parameter used in SINR calculation, noise power σₙ². With Boltzmann's constant as k_{B}, absolute temperature as T, noise figure as F, and bandwidth as W, the noise power σₙ² is calculated according to the following formula (25). As values of respective parameters, values of T=290K, F=9 dB, for example, are used. Since the SINR calculation is performed in subcarrier parts, the value of w may be at subcarrier intervals (15 kHz in LTE).

Formula 25

σₙ²=k_{B}TFW Formula (25)

### Second Exemplary Embodiment

In the present exemplary embodiment a radio apparatus 3 generates an orthogonal channel response (Orthogonal Channel Response) for each layer using estimated value of channel response, and sends this to a control apparatus 200.

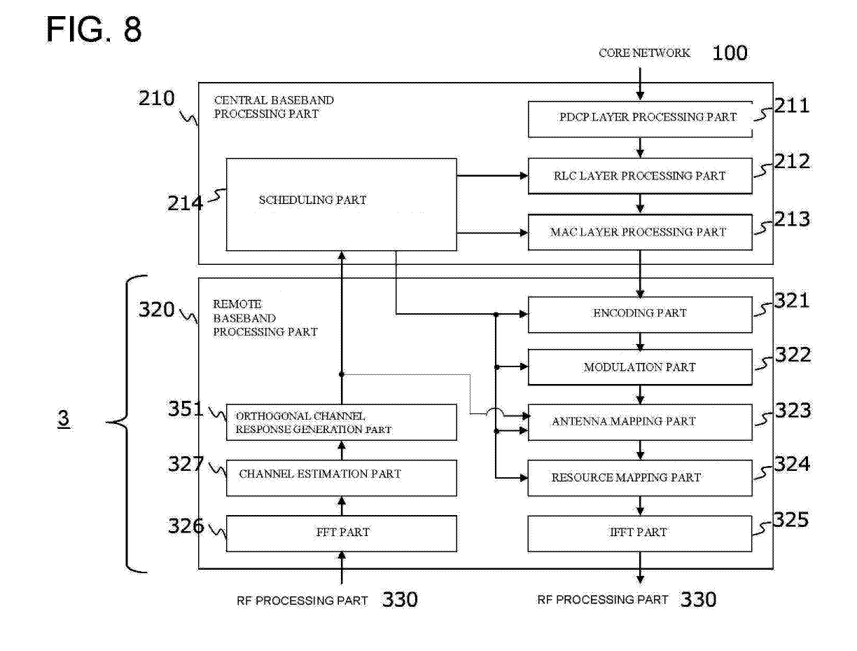

As shown in FIG. 8, a remote baseband processing part 320 in the present exemplary embodiment differs, in comparison with the remote baseband processing part 320 in the first exemplary embodiment shown in FIG. 2, in being provided with an orthogonal channel response generation part 351.

The orthogonal channel response generation part 351 uses an estimated value of channel response between the radio apparatus 3 and a radio terminal 4 received from a channel estimation part 327, to generate an orthogonal channel response for each layer, and outputs this to a scheduling part 214 of the central baseband processing part 210 and an antenna mapping part 323. It is to be noted that the radio terminal in question that generates an orthogonal channel response for each layer is not limited to a radio terminal that communicates with the radio apparatus 3, and a channel response may also be generated for each layer with respect to a radio terminal that communicates with another radio apparatus.

The configuration otherwise is similar to other exemplary embodiments.

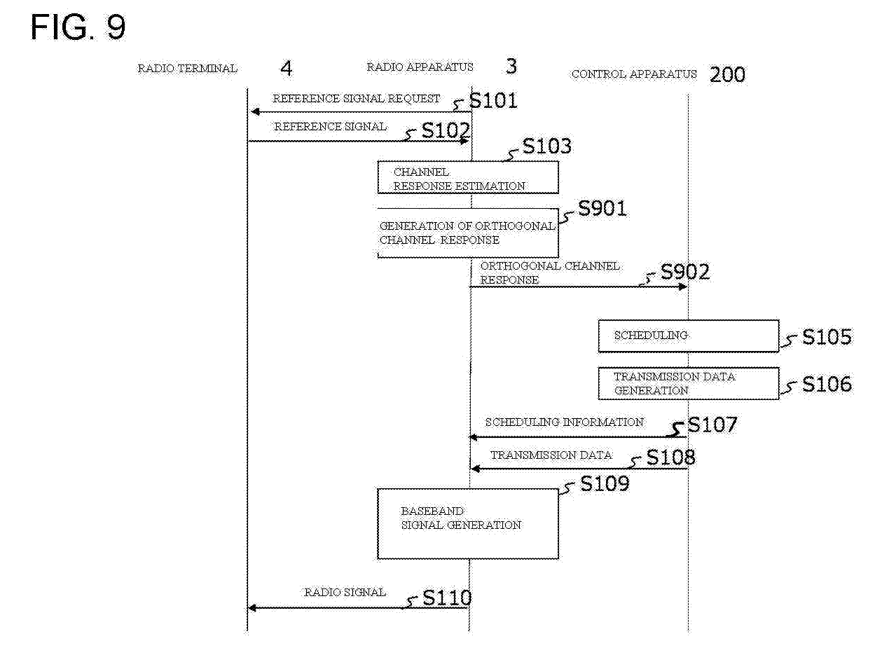

As shown in FIG. 9, in the radio apparatus 3 in the present exemplary embodiment, in comparison to the radio apparatus 3 in the first exemplary embodiment shown in FIG. 3, the orthogonal channel response generation part 351 generates an orthogonal channel response for each layer using an estimated value of the channel response (operation S901), and transmits the orthogonal channel response for each layer that has been generated to the control apparatus 200 (operation S902).

A method of generating an orthogonal channel response for each layer in operation S901 is similar to the method using formula (4) in the first exemplary embodiment. That is, using a right singular vector and singular values generated by singular value decomposition of a channel response matrix having elements of estimated values of channel response, or eigenvectors and eigenvalues generated by eigenvalue decomposition of the product of the Hermitian transpose of the channel response matrix and the channel response matrix, an orthogonal channel response for each layer is generated according to formula (4). It is to be noted that before performing the singular value decomposition or the eigenvalue decomposition, time-frequency based averaging processing may be performed on the product of the channel response matrix or the Hermitian transpose of the channel response matrix and the channel response matrix.

In operation S902, transmission to the control apparatus 200 may be performed not with the orthogonal channel response vector for each layer, but by dividing into that vector norm and a channel response vector normalized by the norm. All orthogonal channel responses generated in operation S901 need not be transmitted, and a limitation may be made to channel responses transmitted based on the norm of the channel response vector. A limitation may be made to channel responses transmitted based on an instruction from the control apparatus 200.

Operations outside of operations S901 and S902 are similar to the first exemplary embodiment. In this regard, as a method of estimating SINR in scheduling in operation S105, the second or third examples indicated in the first exemplary embodiment are used.

As described above, in the present exemplary embodiment when MU-MIMO transmission is used with a C-RAN configuration, a configuration is used in which an orthogonal channel response generation part is provided that generates an orthogonal channel response based on a reference signal in the radio apparatus, and the control apparatus performs scheduling using an orthogonal channel response received from the radio apparatus. As a result, in comparison to a configuration in which a channel estimation result is transmitted to the control apparatus from the radio apparatus, it is possible to reduce front-haul communication volume.

### Third Exemplary Embodiment

In the present exemplary embodiment a radio apparatus 3 calculates gain of channels of each layer of each radio terminal and correlation with channels between layers of different terminals, and sends these to the control apparatus 200.

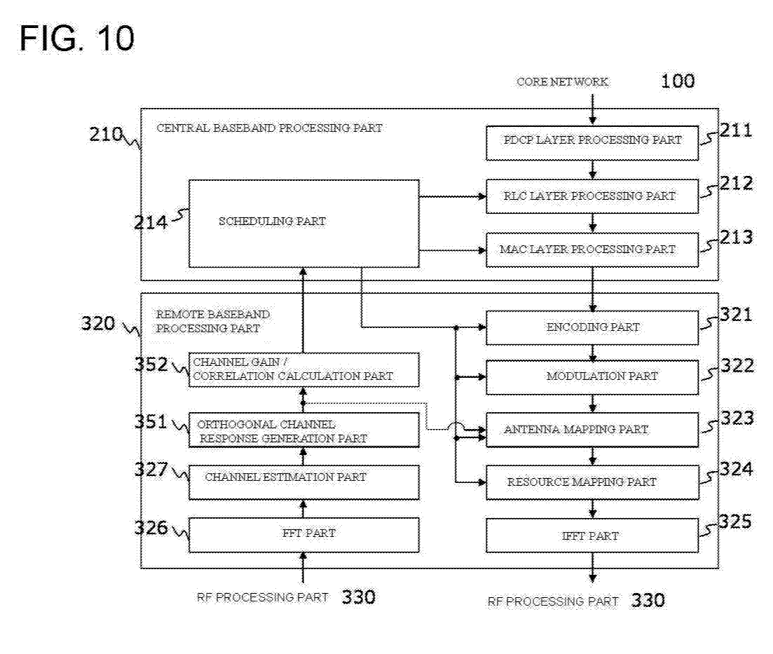

As shown in FIG. 10, a remote baseband processing part 320 in the present exemplary embodiment differs, in comparison with the remote baseband processing part 320 in the second exemplary embodiment shown in FIG. 8, in being provided with a channel gain/correlation calculation part 352.

The channel gain/correlation calculation part 352 uses an orthogonal channel response for each layer between the radio apparatus 3 and a radio terminal 4, received from the orthogonal channel response generation part 351, calculates gain of channels of respective layers and correlation with channels between layers of different terminals, and outputs these to a scheduling part 214 of the central baseband processing part 210. It is to be noted that the radio terminal in question that calculates gain of channels for respective layers and correlation of channel among layers of different terminals is not limited to radio terminals communicating with the radio apparatus 3, and gain of channels for respective layers for radio terminals communicating with other radio apparatuses, and correlation of channels among layers of different terminals, may also be calculated. The gain and correlation calculated by the channel gain/correlation calculation part 352 are not limited to gain of channels for respective layers and correlation of channel among layers of different terminals; estimated values of channel responses outputted by a channel estimation part 327 may be used, and gain of channels of respective radio terminals and correlation of channels among different terminals, are also possible.

The configuration otherwise is similar to other exemplary embodiments.

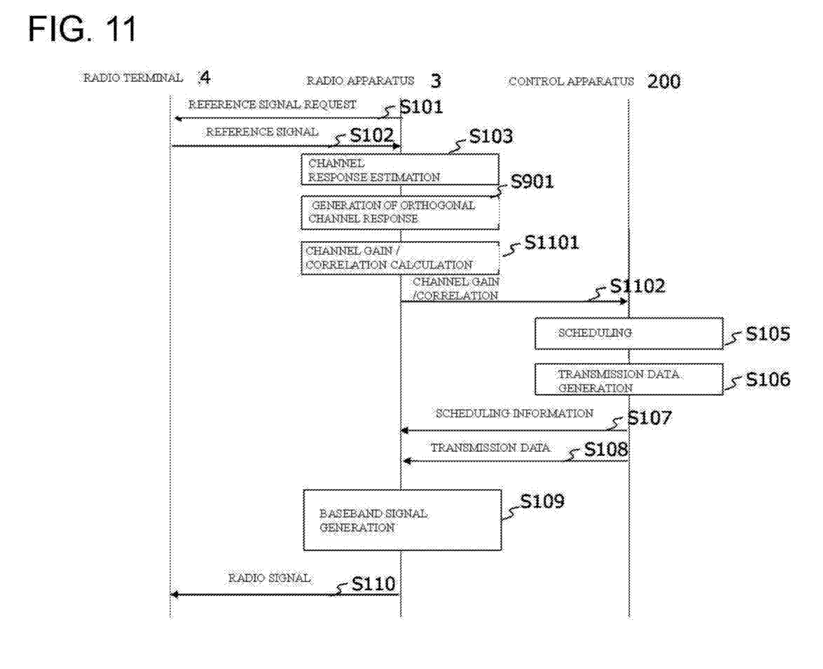

As shown in FIG. 11, in the radio apparatus 3 in the present exemplary embodiment, in comparison to the radio apparatus 3 in the second exemplary embodiment shown in FIG. 9, the channel gain/correlation calculation part 352 uses orthogonal channel responses for respective layers to calculate gain of channels for respective layers and correlation of channels among layers of different terminals (operation S1101), and transmits the calculated gain of channels for respective layers and correlation of channel among layers to the control apparatus 200 (operation S1102). In operation S1101, gain of the channels of respective layers is calculated as the norm of the orthogonal channel response vector for respective layers. Correlation of channels among layers is calculated from formula (7) of the first exemplary embodiment using the orthogonal channels response of respective layers.

In operation S1102, gain of all channels and correlation of channels between terminals, calculated in operation S1101 need not be transmitted, and a limitation may be made to transmission based on the values of channel gain and correlation of channels among terminals. A limitation may also be made to gain of channels and correlation of channel among terminals, transmitted based on an instruction from the control apparatus 200.

Operations outside of operations S1101 and S1102 are similar to the second exemplary embodiment. In this regard, as a method of estimating SINR in scheduling in operation S105, the third example indicated in the first exemplary embodiment is used.

As described above, in the present exemplary embodiment when MU-MIMO transmission is used with a C-RAN configuration, a configuration is provided with a channel gain/correlation generation part, that calculates channel gain of respective layers of each radio terminal based on reference signals in a radio apparatus, and channel correlation between layers of different terminals, and the control apparatus performs scheduling using channel gain and correlation received from the radio apparatus. As a result, in comparison to a configuration in which an orthogonal channel response is transmitted to the control apparatus from the radio apparatus, it is possible to reduce front-haul communication volume.

### Fourth Exemplary Embodiment

In the present exemplary embodiment a radio apparatus 3 generates a transmit weight matrix using estimated values of channel responses, and sends this to a control apparatus 200.

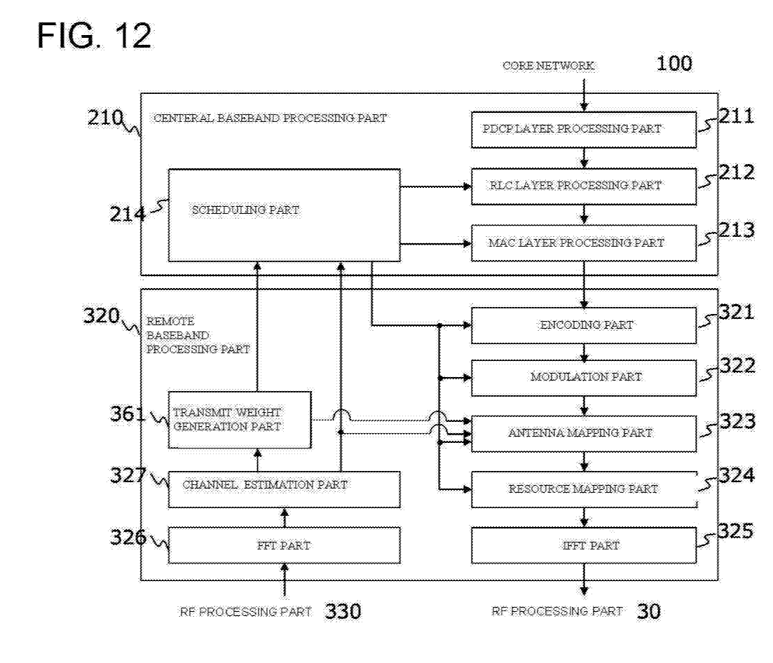

As shown in FIG. 12, a remote baseband processing part 320 in the present exemplary embodiment, in comparison with the remote baseband processing part 320 in the first exemplary embodiment shown in FIG. 2, differs in being provided with a transmit weight generation part 361. The transmit weight generation part 361 uses estimated values of channel response between a radio apparatus 3 and a radio terminal 4 received from the channel estimation part 327, to generate a transmit weight matrix, and outputs these to a scheduling part 214 of a central baseband processing part 210.

It is to be noted that the orthogonal channel response generation part 351 in the second exemplary embodiment may be provided with a remote baseband processing part 320, and may generate a transmit weight matrix using orthogonal channel responses for respective layers.

The configuration otherwise is similar to other exemplary embodiments.

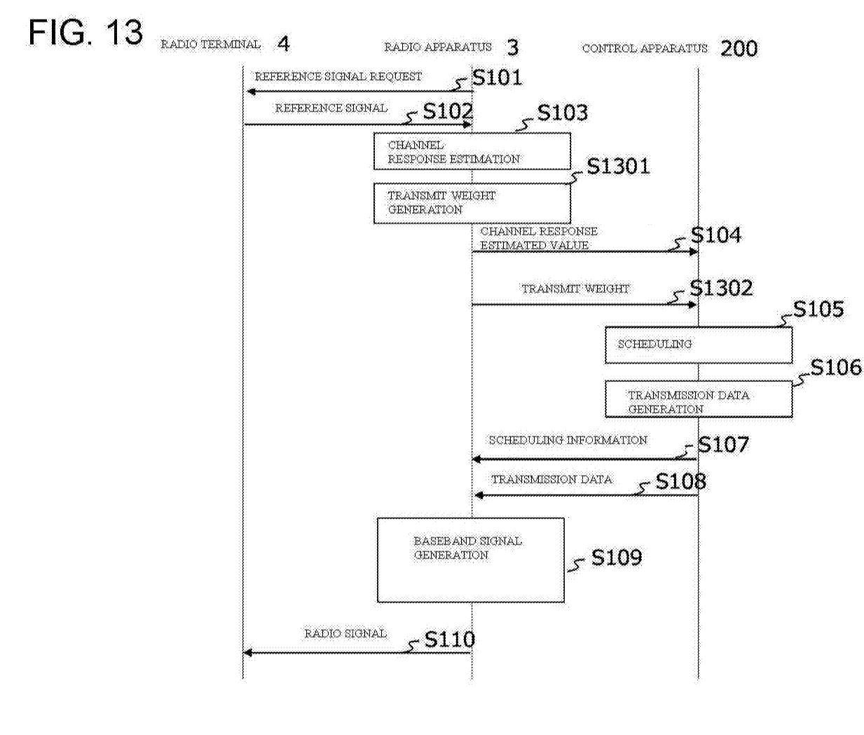

As shown in FIG. 13, in the radio apparatus 3 in the present exemplary embodiment, in comparison to the radio apparatus 3 in the first exemplary embodiment shown in FIG. 3, a transmit weight generation part 361 generates a transmit weight using an estimated value of the channel response (operation S1301), and transmits the generated transmit weight to the control apparatus 200 (operation S1302).

In operation S1301, the transmit weight matrix is generated for each combination of several radio terminal, selected based on correlation of channels among terminals, communication frequency of respective radio terminals and the like. As generation criteria for transmit weight, MRT, ZF, SLNR or the like are used.

Operations outside of operations S1301 and S1302 are similar to the first exemplary embodiment.

As described above, in the present exemplary embodiment, when MU-MIMO transmission is used with a C-RAN configuration, a configuration is used in which a transmit weight generation part is provided in the radio apparatus, and the control apparatus performs scheduling using transmit weight and channel estimation results received from the radio apparatus. As a result, there is no need to provide a generating function for transmit weight in the control apparatus, and it is possible to reduce the cost of the control apparatus.

### Other Exemplary Embodiments

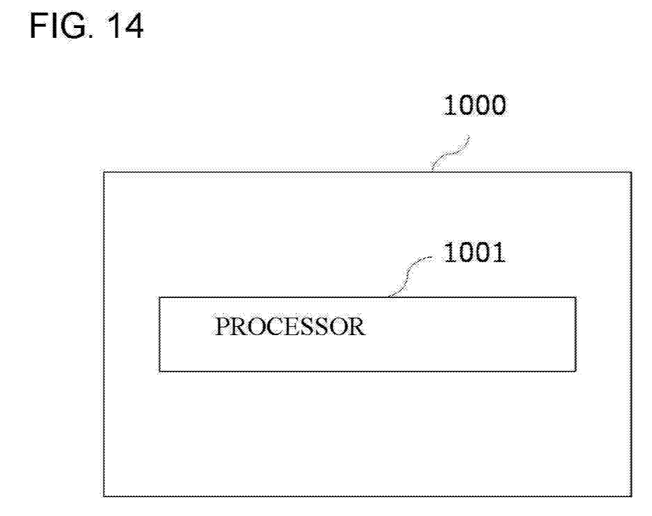

It is to be noted that respective functions included in the radio apparatus and control apparatus in the respective exemplary embodiments described above may be realized by executing 1 or more programs in a computer device (processor) 1001, with regard to a microprocessor, circuit, transmitter, receiver and the like included in a device 1000 as described in FIG. 14. These programs may be housed using various types of non-transitory computer-readable media and supplied in a computer. The non-transitory computer-readable media include recording media having various types of implementation. Examples of the non-transitory computer-readable media include magnetic recording media, magneto-optical recording media, CD (Compact Disc), DVD (Digital Versatile Disc), BD (Blu-ray Disc) and semiconductor memory. The programs may be supplied in a computer by means of various types of non-transitory computer-readable media. Examples of non-transitory computer-readable media include electrical signals, optical signals, and electromagnet waves. The non-transitory computer-readable media may supply programs to a computer via wired communication channels such as electrical wires and optical fibers, or wireless communication channels.

It is to be noted that the present invention is not limited to the abovementioned exemplary embodiments as is, and in the implementation phase, component elements may be realized as modifications thereof within a scope that does not depart from the fundamentals of the invention. Various forms of the invention are possible by combining as appropriate multiple component elements disclosed in the abovementioned exemplary embodiments. For example, several component elements may be removed from the entirety of component elements disclosed in the exemplary embodiments. In addition, component elements in different exemplary embodiments may be combined as appropriate.

It is to be noted that the following modes are possible in the present invention.

### First Mode

As in the radio apparatus according to a first aspect described above.

### Second Mode

The radio apparatus according to the first mode, wherein the radio apparatus is provided with a receiving part that receives a reference signal from the radio terminal, and the channel estimation part estimates a channel response based on the reference signal.

### Third Mode

The radio apparatus according to the first or second mode, wherein the channel information has a smaller quantity of information than the channel response.

### Fourth Mode

The radio apparatus according to any one of the first to third modes, wherein the channel information is at least one of channel response, orthogonal channel response, channel gain, channel correlation and transmit weight.

### Fifth Mode

The radio apparatus according to any one of the first to fourth modes, physically separated from the control apparatus, and connected to the control apparatus via a fronthaul.

### Sixth Mode

The radio apparatus according to any one of the first to fifth modes, wherein the radio terminal is a radio terminal that communicates with the radio apparatus or another radio apparatus.

### Seventh Mode

The radio apparatus according to any one of the first to sixth modes, wherein the radio apparatus is provided with a receiving part that receives scheduling information from the control apparatus, and the scheduling information includes information of spatially multiplexing resources allocated to a plurality of terminals.

### Eighth Mode

As in the control apparatus according to the second aspect described above.

### Ninth Mode

The control apparatus according to the eighth mode, wherein the channel response is a channel response estimated based on a reference signal transmitted from the radio terminal.

### Tenth Mode

The control apparatus according to the eighth or ninth mode, wherein the channel information has a smaller quantity of information than the channel response.

### Eleventh Mode

The control apparatus according to any one of the eighth to tenth modes, wherein the channel information is at least one of channel response, orthogonal channel response, channel gain, channel correlation and transmit weight.

### Twelfth Mode

The control apparatus according to any one of the eighth to eleventh modes, physically separated from the radio apparatus, and connected to the radio apparatus via a fronthaul.

### Thirteenth Mode

The control apparatus according to any one of the eighth to twelfth modes, wherein the radio terminal is a radio terminal that communicates with the radio apparatus or another radio apparatus.

### Fourteenth Mode

The control apparatus according any one of the eighth to thirteenth modes, wherein the scheduling information includes information of spatially multiplexing resources allocated to a plurality of terminals.

### Fifteenth Mode

As in the radio communication system according to a third aspect described above.

### Sixteenth Mode

The radio communication system according to the fifteenth mode, wherein the channel response is a channel response estimated based on a reference signal transmitted from the radio terminal.

### Seventeenth Mode

The radio communication system according to the fifteenth or sixteenth mode, wherein the channel information has a smaller quantity of information than the channel response.

### Eighteenth Mode

The radio communication system according to any one of the fifteenth to seventeenth modes, wherein the radio apparatus and the control apparatus are physically separated, and connected via a fronthaul.

### Nineteenth Mode

The radio communication system according to any one of the fifteenth to eighteenth modes, wherein the radio terminal is a radio terminal that communicates with the radio apparatus or another radio apparatus.

### Twentieth Mode

The radio communication system according to any one of the fifteenth to nineteenth modes, wherein the scheduling information includes information of spatially multiplexing resources allocated to a plurality of terminals.

### REFERENCE SIGNS LIST

30: fronthaul
<network>
100: core network
<control apparatus>
200: control apparatus
22: receiving part
23: transmission part
210: central baseband processing part
211: PDCP layer processing part
212: RLC layer processing part
213: MAC layer processing part
214: scheduling part
220: fronthaul interface processing part (fronthaul IF processing part)
<radio apparatus>
3, 300-1, 300-2: radio apparatus
33: channel information generation part
34: transmission part
310: fronthaul interface processing part (fronthaul IF processing part)
320: remote baseband processing part
321: encoding part
322: modulation part
323: antenna mapping part
324: resource mapping part
325: IFFT part
326: FFT part
327: channel estimation part
330: RF processing part
340: antenna
351: orthogonal channel response generation part
352: channel gain/correlation calculation part
361: transmit weight generation part
<radio terminal>
4, 400-1 to 400-3: radio terminal
<device>
1000: device
1001: processor

What is claimed is:

1. A radio apparatus, comprising:
a channel estimation part that estimates a channel response between a radio terminal and said radio apparatus itself;
a channel information generation part that generates channel information from said estimated channel response; and
a transmission part that transmits said generated channel information to a control apparatus.

2. The radio apparatus according to claim 1, wherein said radio apparatus comprises a receiving part that receives a reference signal from said radio terminal, and
said channel estimation part estimates channel response using said reference signal.

3. The radio apparatus according to claim 1, wherein said channel information has a smaller quantity of information than said channel response.

4. The radio apparatus according to claim 1, wherein said channel information is at least one of: channel response, orthogonal channel response, channel gain, channel correlation and transmit weight.

5. The radio apparatus according to claim 1, physically separated from said control apparatus, and connected to said control apparatus via a fronthaul.

6. The radio apparatus according to claim 1, wherein said radio terminal is a radio terminal that communicates with said radio apparatus or another radio apparatus.

7. The radio apparatus according to claim 1, wherein said radio apparatus comprises a receiving part that receives scheduling information from said control apparatus, and
said scheduling information comprises information of resources allocated to said radio terminals.

8. A control apparatus, comprising:
a receiving part that receives channel information that a radio apparatus generates using an estimated channel response between a radio terminal and said radio apparatus,
a scheduling part that generates scheduling information from said channel information, and
a transmission part that transmits said scheduling information to said radio apparatus.

9. The control apparatus according to claim 8, wherein said channel response is a channel response estimated using a reference signal transmitted by said radio terminal.

10. The control apparatus according to claim 8, wherein said channel information has a smaller quantity of information than said channel response.

11. The control apparatus according to claim 8, wherein said channel information is at least one of: channel response, orthogonal channel response, channel gain, channel correlation and transmit weight.

12. The control apparatus according to claim 8, physically separated from said radio apparatus, and connected to said radio apparatus via a fronthaul.

13. The control apparatus according to claim 8, wherein said radio terminal is a radio terminal that communicates with said radio apparatus or another radio apparatus.

14. The control apparatus according to claim 8, wherein said scheduling information comprises information of resources allocated to said radio terminals.

15. A radio communication system, comprising
a radio apparatus and a control apparatus; wherein
said radio apparatus comprises a channel estimation part that estimates a channel response between a radio terminal and said radio apparatus;
a channel information generation part that generates channel information from said channel response; and
a transmission part that transmits said channel information to said control apparatus; and wherein
said control apparatus comprises a scheduling part that generates scheduling information from said channel information, and
a transmission part that transmits said scheduling information to said radio apparatus.

16. The radio communication system according to claim 15, wherein said channel response is a channel response estimated using a reference signal transmitted by said radio terminal.

17. The radio communication system according to claim 15, wherein said channel information has a smaller quantity of information than said channel response.

18. The radio communication system according to claim 15, wherein said radio apparatus and said control apparatus are physically separated, and connected via a fronthaul.

19. The radio communication system according to claim 15, wherein said radio terminal is a radio terminal that communicates with said radio apparatus or another radio apparatus.

20. The radio communication system according to claim 15, wherein said scheduling information comprises information of resources allocated to said radio terminals.
